(19) United States
(12) Patent Application Publication
(10) Pub. No.: US 2018/0023236 A1
(43) Pub. Date: Jan. 25, 2018

(54) SENSOR DATA LEARNING METHOD AND SENSOR DATA LEARNING DEVICE

(71) Applicant: FUJITSU LIMITED, Kawasaki-shi (JP)

(72) Inventor: Shigeyuki ODASHIMA, Tama (JP)

(73) Assignee: FUJITSU LIMITED, Kawasaki-shi (JP)

(21) Appl. No.: 15/648,013

(22) Filed: Jul. 12, 2017

(30) Foreign Application Priority Data
Jul. 19, 2016 (JP) 2016-141490

(51) Int. Cl. D06F 39/00; G06N 3/08; G06N 99/00

(52) U.S. Cl. CPC D06F 39/002; G06N 99/005; G06N 3/08

(57) ABSTRACT

A sensor data learning method executed by a computer, includes acquiring sensor data, collecting the acquired sensor data at each representative point of a plurality of pieces of similar sensor data, and calculating reliability of a data type associated with the representative point based on the data type granted to each of the plurality of pieces of sensor data.

### CROSS-REFERENCE TO RELATED APPLICATION

This application is based upon and claims the benefit of priority of the prior Japanese Patent Application No. 2016-141490, filed on Jul. 19, 2016, the entire contents of which are incorporated herein by reference.

### FIELD

The embodiments discussed herein are related to a sensor data learning method and a sensor data learning device.

### BACKGROUND

In recent years, machine learning is applied to various fields. To perform a learning process in user environments, there are restrictions on storage capacities for retaining a large amount of data in each user environment and restrictions on performance of computers such as loads or the like of learning processes.

It is considered that learning processes are performed on collection of input similar data. From viewpoints of collection of similar data, technologies for manually or automatically integrating similar or overlapping items and technologies for generating initial clusters corrected from objects with the same hash values and generating final clusters from the similar initial clusters.

Japanese Laid-open Patent Publication No. 2013-065276, Japanese Laid-open Patent Publication No. 2013-130965, Japanese Laid-open Patent Publication No. 2007-026115, and Japanese Laid-open Patent Publication No. 2014-026455 are examples of the related art.

### SUMMARY

According to an aspect of the invention, a sensor data learning method executed by a computer, includes acquiring sensor data, collecting the acquired sensor data at each representative point of a plurality of pieces of similar sensor data, and calculating reliability of a data type associated with the representative point based on the data type granted to each of the plurality of pieces of sensor data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overview of sequential learning;

FIGS. 2A to 2C are diagrams illustrating representative machine learning;

FIG. 3 is a diagram illustrating existing core set learning;

FIGS. 4A and 4B are diagrams illustrating sound recognition by weighted learning;

FIG. 5 is a diagram illustrating the number of pieces of data and labeling;

FIG. 6 is a diagram illustrating a hardware configuration of a sensor data learning device according to a first example;

FIG. 7 is a diagram illustrating an application example of a watching system;

FIG. 8 is a diagram illustrating a functional configuration example of the sensor data learning device according to the first example;

FIG. 9 is a diagram illustrating a first data configuration example of a representative point DB;

FIG. 10 is a diagram illustrating a second data configuration example of the representative point DB;

FIG. 11 is a diagram illustrating a data configuration example of a discrimination function DB;

FIG. 12 is a diagram illustrating a calculation example of reliability according to the first example;

FIGS. 13A to 13C are diagrams illustrating a difference in a discrimination function according to a related technology and the first example;

FIG. 14 is a diagram illustrating an example of a case in which a user is warned according to the first example;

FIGS. 15A and 15B are diagrams illustrating an example of a labeling confirmation screen according to the first example;

FIGS. 16A and 16B are diagrams illustrating timing examples of the labeling;

FIG. 17 is a flowchart illustrating a reliability acquisition process according to the first example;

FIG. 18 is a flowchart illustrating a learning process according to the first example;

FIG. 19 is a diagram illustrating a functional configuration example of a sensor data learning device according to a second example; and

FIG. 20 is a flowchart illustrating a living sound recognition process.

### DESCRIPTION OF EMBODIMENTS

In a learning process under a user environment, certain sensor data is input as detected sensor data (a sound or the like), but it is difficult for a user to determine a solution to the detected sensor data in some cases. In a case in which the solution is uncertain (precision is low), there is a concern that learning in which recognition precision is consequently lowered is performed.

Accordingly, according to an aspect of the present disclosure, an object of the present disclosure is to perform learning in which recognition precision of input sensor data is improved.

Hereinafter, an embodiment of the present disclosure will be described with reference to the drawings. With advance in artificial intelligence technologies and development in technologies, for example, a motion of introducing artificial intelligence to an individual user environment and using the artificial intelligence by a service such as a smart home supporting people such as elderly people is active. A service in which an artificial intelligence technology is generally realized by a machine learning process.

However, when the artificial intelligence technology is introduced to such an “individual user environment”, a learning process is not completed before factory shipment. As it were, it is important to provide an artificial intelligence technology customized for each user to realize artificial intelligence of “only the user” in an individual user environment by performing a learning process.

A service tailored for a user and associated with a learned result in a user environment can be provided by such an artificial intelligence system. For example, a watching system by a living sound can be realized as a system that learns a toilet sound produced every day and notifies a user of abnormality in a case in which the toilet sound is not detected. In the system, a sequential learning technology for performing a learning process in a user environment is used.

“Learning” is a process of obtaining a recognition model that outputs a label associated with sensor data such as a finally detected living sound or the like. The label is a character string indicating kinds of sounds such as “door sound”, “chime sound”, “drawing sound”, “washing machine sound”, “toilet sound”, “vacuum cleaner sound”, “cooking sound”, and the like associated with detection sounds of a sensor installed in a house.

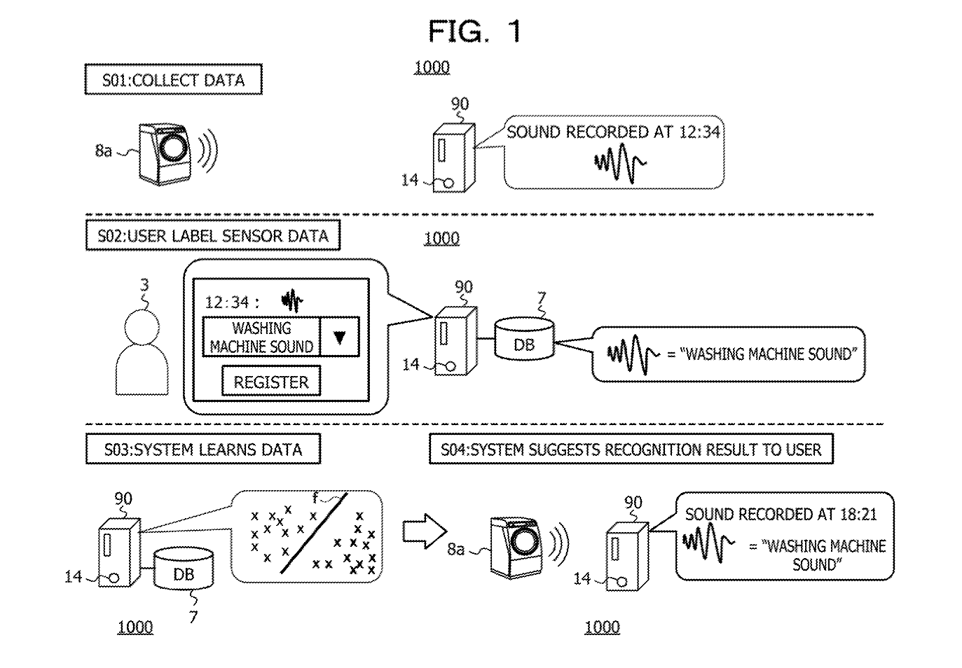

First, an overview of the sequential learning will be described. FIG. 1 is a diagram illustrating the overview of the sequential learning. In FIG. 1, a case in which the sequential learning is applied to a watching system 1000 by a living sound will be described.

The watching system 1000 is a system in which a sensor data learning device 90 is installed in a house, collects various sounds of a washing machine 8a and the like using a sound sensor 14, and notifies family members or involved people of people living in the house of situations of the people based on sound-produced situations of kinds of produced sounds, kinds of sounds not produced for a long time, and the like in a case in which the situations are determined to be reported or abnormal.

The sensor data learning device 90 collects sensor data in the user environment of a house or the like (step S01). The sensor data is equivalent to a multi-dimensional vector indicating an audio feature amount of a different sound from a sound at ordinary times detected by a sound pressure change or the like by the sound sensor 14. The sensor data is simply referred to as “data” or “sound data” in some cases.

The sensor data in the watching system 1000 is assumed to target sounds such as a door sound, a chime sound, and a drawing sound in a house. The sensor data learning device 90 accumulates the sensor data in a database (DB) 7.

Next, the sensor data learning device 90 displays a labeling confirmation screen G95 and urges a user 3 to label sensor data retained in the database (DB) 7 (step S02). Through the labeling, one of labels of the door sound, the chime sound, the drawing sound, and the like is selected and a sound producing source is specified. The label selected by the user 3 through the labeling is associated with the detected sound.

Then, the sensor data learning device 90 generates a label recognition model by performing a machine learning process when a certain amount or more of sensor data associated with the labels is accumulated in the DB 7 (step S03). The sensor data learning device 90 performs a process of acquiring a discrimination function f of acquiring a model, such as a support vector machine (SVC), boosting, or a neural network, which recognizes a label from a sound detected by the sound sensor 14.

When the machine learning process is completed, the labeling is automatically performed on newly input sensor data to be suggested to the user 3. The learning process is not completed only once, but the machine learning process may be performed a plurality of times by feeding determination of whether the labeling suggested to the user 3 is matched back to the user 3.

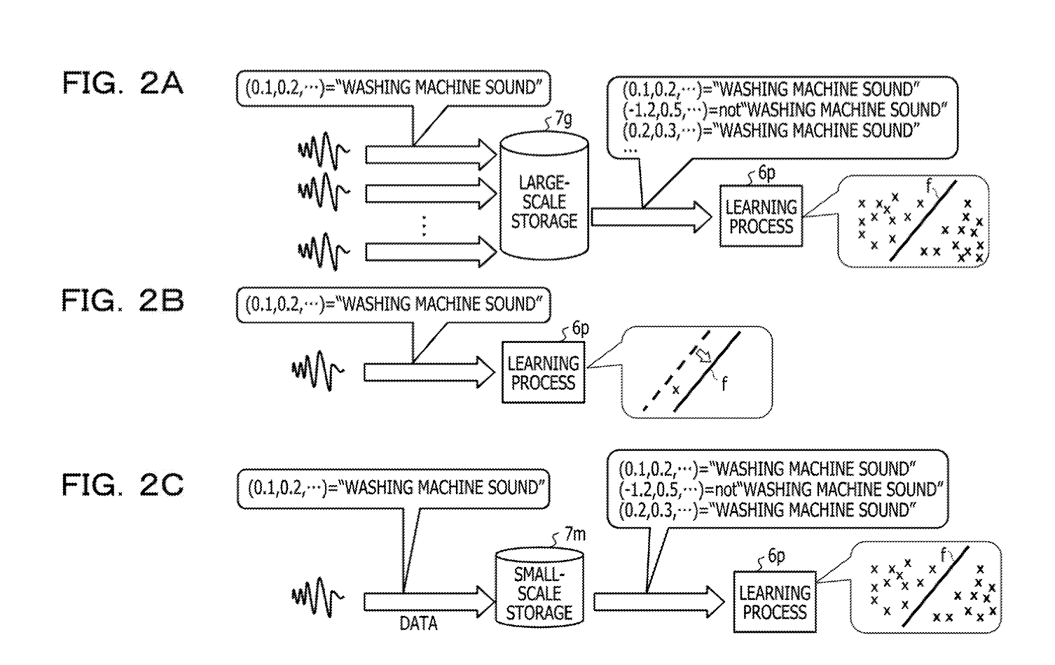

In realization of the sequential learning, a machine learning process performed by the sensor data learning device 90 is a key. First, an overview of a main scheme of the machine learning process will be described. FIGS. 2A to 2C are diagrams illustrating representative machine learning.

FIG. 2A illustrates an example of batch learning. In the batch learning, all learning data is retained in a large-scale storage 7g and the discrimination function f is acquired through a learning process 6p. Since the learning process 6p is performed using all the data accumulated in the large-scale storage 7g, high precise learning can be performed.

However, the large-scale storage 7g that retains a large amount of learning data is indispensable, large-scale computer resources used to perform optimization calculation on the large amount of learning data are indispensable, and it is difficult to perform sequential learning using a batch learning scheme in a user environment in a house or the like.

FIG. 2B illustrates an example of online learning. In the online learning, a discrimination function is updated whenever a pair of sensor data and a label is input. The discrimination function is updated when a small amount of learning data is input. Therefore, a large amount of data is not retained, that is, the large-scale storage 7g is not indispensable and the learning process 6p can be performed without including a high-performance computer. However, to preserve only local data, there is a disadvantage that a result obtained through the learning process 6p becomes easily unstable.

FIG. 2C illustrates an example of core set learning. The core set learning is a method in which there are both the advantages of the batch learning and the online learning. A representative point called a “core set” is selected as a weighted point from all data. Points at close distances on a feature amount space are extracted as representative points using a clustering process or the like on all data. The representative points are weighted to perform the learning process 6p.

Each piece of data is represented as an audio feature amount by a plurality of parameter values and can be considered as a point in the feature amount space. The representative point is representative data selected in a cluster in which similar data is collected.

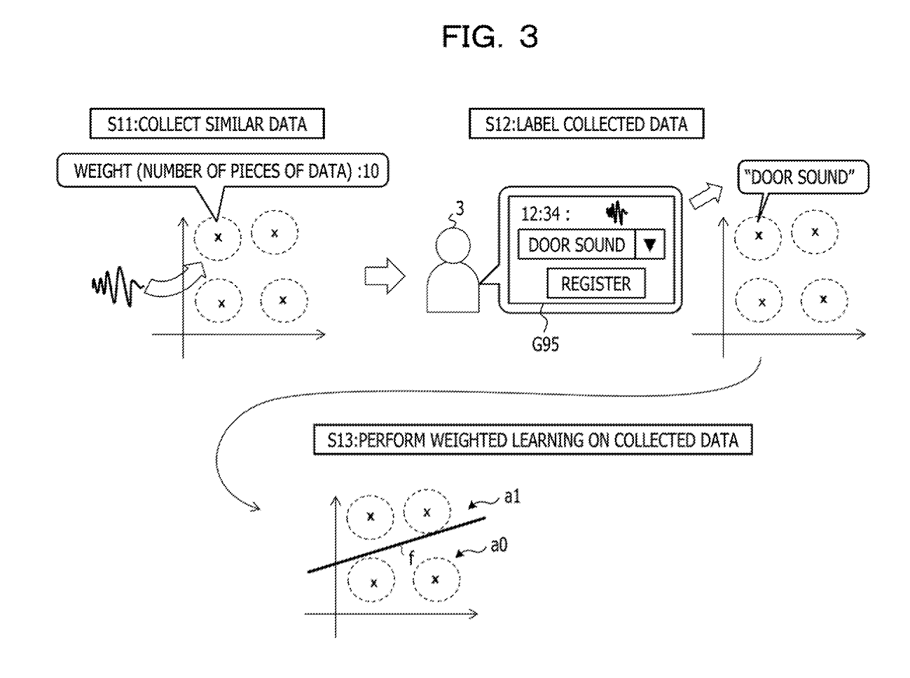

FIG. 3 is a diagram illustrating existing core set learning. In the core set learning illustrated in FIG. 3, representative points are extracted based on labels and sensor data input to the sensor data learning device 90. After a fixed number of pieces of sensor data are input, similar data is collected at the plurality of representative points in accordance with a clustering scheme or the like (step S11). The number of pieces of data belonging to each cluster is retained as a weight.

Next, the user 3 is caused to label the collected data (step S12). Thereafter, the sensor data learning device 90 acquires the discrimination function f by performing the learning process 6p by the weighting based on the number of pieces of data of the cluster (step S13). The learning process 6p by the weighting is simply referred to as “weighted learning” in some cases.

At the time of sound recognition, even in a location in which there is no data in any cluster, the sensor data learning device 90 determines whether data is in a door sound region a1 or a non-door sound region a0 using the acquired discrimination function f.

Unlike a normal learning process in which data used for learning can be selected, learning is performed in a user environment in the sequential learning, so to speak, using data in which noise is large. In such a situation, some of the sensor data also include sensor data which is not discriminated for a user, a possibility of erroneously labeling being consequently performed increases.

At the time of labeling to living sounds by the user 3, there is a concern that opening and closing sounds of a cupboard are also included and labeled in a case in which “door sound” is labeled.

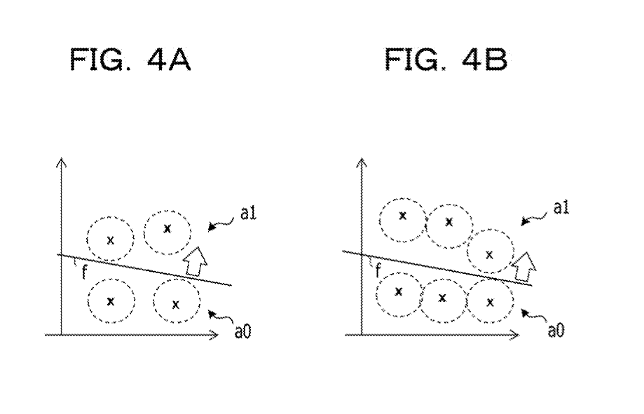

FIGS. 4A and 4B are diagrams illustrating sound recognition by weighted learning. In FIG. 4A, a case in which the number of pieces of data is large will be described. In a case in which the number of pieces of data in a cluster is large, the weight increases. As the weight increases, a distance from the discrimination function f is lengthened. By increasing the weight, learning in which erroneous recognition is difficult is performed.

In FIG. 4B, a case in which the number of pieces of data is small will be described. In a case in which the number of pieces of data in a cluster is small, the weight decreases. As the weight decreases, the distance from the discrimination function f is shortened. In a case in which learning of the discrimination function may not be performed so that all the data is correctly identified, learning of the discrimination function is performed so that data in which the weight is small is erroneous.

A weighted point is represented as the number of collected points close on a feature amount space. Accordingly, a label of sensor data with a large number of occurrences is highly weighted and the learning process 6p is performed non-erroneously. However, in a case in which the data with a large number of occurrences is labeled in an ambiguous state, there is a concern that label determination of data labeled with confidence is erroneous although the number of occurrences is small and a learning process is performed so that a label of data with a large number of occurrences is a solution although being ambiguous.

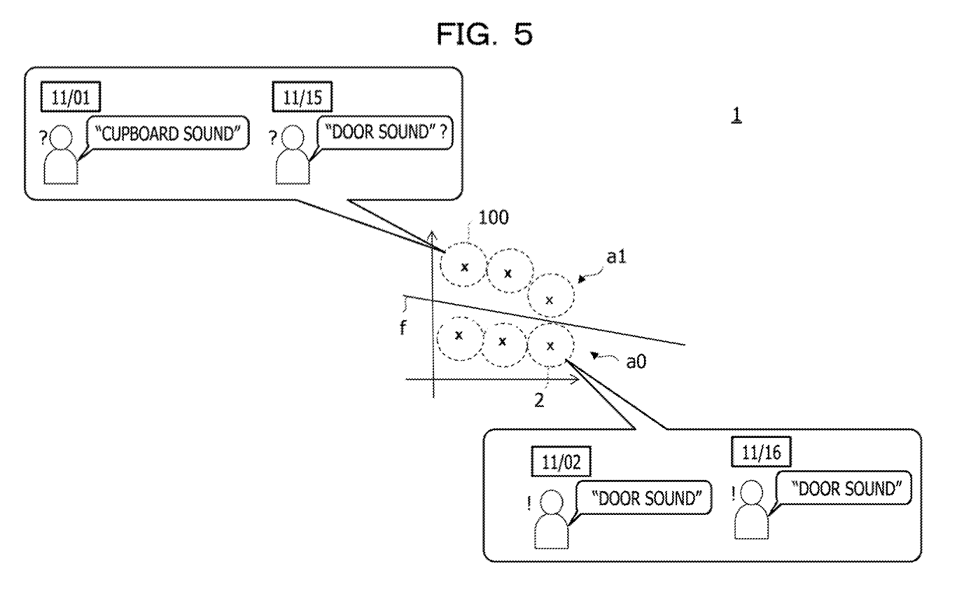

FIG. 5 is a diagram illustrating the number of pieces of data and labeling. In FIG. 5, a difference in the degree of confidence of labeling by the user 3 will be described exemplifying a cluster with a weight of “100” in the door sound region a1 and a cluster with a weight of “2” in the non-door sound region a0 in the feature amount space 1.

The cluster with the weight of “100” indicates that the number of pieces of data is large. It is assumed that the user 3 does not specify an origination source of a sound and hesitate to determine which the sound is at the time of labeling 10 pieces of data (sounds) of the cluster.

The user 3 sets the sound as “cupboard sound” on 1 November and sets the sound as “door sound” on 15 November without confidence. In this case, although the number of pieces of data is large, the label may not be fixed and the sensor data learning device 90 may not recognize the sound with high precision.

Conversely, it is assumed that the user 3 labels each sound with confidence in the cluster with the weight of “2” in which the number of pieces of data is small. The user 3 sets the sound as “door sound” on 2 November and also similarly sets the sound as “door sound” on 16 November with confidence. In this case, since the number of pieces of data is small, the sensor data learning device 90 may erroneously recognize the data with a small weight.

The user 3 mistakes data in the cluster in which the labeling is performed with confidence although the number of pieces of data is small, and the learning process 6p is performed using, as a solution, the labeling of the data belonging to the cluster in which the labeling is performed in an ambiguous state although the number of pieces of data is large. As a result, a discrimination function not suitable for an intuition of the user 3 is learned. When the weight of the data labeled confidently by the user 3 is small, recognition of the data may be erroneous and the recognition precision in the user 3 may be determined to be poor.

Accordingly, according to a first example, a weight of data is decided using reliability of the labeling of the user 3 calculated with consistency of labels set for data of a cluster in sequential learning. A weight of data with low reliability is lowered and the learning process 6p is performed.

In labeling in which the degree of confidence of the user 3 is high, consistent labels are expected to be set. That is, the same label as the label of “door sound” or the like is set for data (sounds) detected by the sound sensor 14.

Conversely, in a case in which the user 3 performs labeling in an ambiguous state, the set labels are expected to be diverse. That is, a plurality of labels such as “door sound” and “cupboard sound” are set for data (sounds) detected by the sound sensor 14. Ambiguity of the labeling is considered to be reflected in reliability of labels set by the user 3. Specifically, reliability of data is calculated by retaining a history of labels set at certain representative points by the user and calculating coincidence of the history.

Sequential learning in which learning is performed in a user environment will be described as an example. However, a situation in which labels are set ambiguously at the time of learning is a problem commonly occurring in systems of machine learning. Accordingly, a scheme disclosed in the first example is not limited to sequential learning, but can be applied to all the systems in which learning is performed.

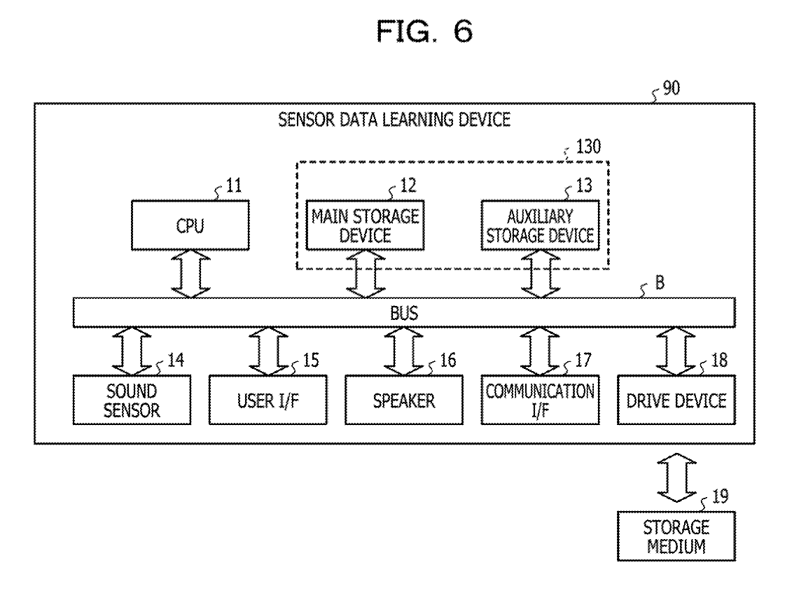

The sensor data learning device 90 according to the first example has a hardware configuration illustrated in FIG. 6. FIG. 6 is a diagram illustrating the hardware configuration of the sensor data learning device according to the first example. In FIG. 6, the sensor data learning device 90 is an information processing device controlled by a computer and includes a central processing unit (CPU) 11, a main storage device 12, an auxiliary storage device 13, a sound sensor 14, a user interface (I/F) 15, a speaker 16, a communication I/F 17, and a drive device 18 which are connected by a bus B.

The CPU 11 is equivalent to a processor that controls the sensor data learning device 90 in accordance with a program stored in the main storage device 12. A random access memory (RAM), a read-only memory (ROM), or the like is used as the main storage device 12. The main storage device 12 stores or temporarily preserves a program to be executed in the CPU 11, data indispensable for a process in the CPU 11, data obtained in a process in the CPU 11, and the like.

A hard disk drive (HDD) or the like is used as the auxiliary storage device 13. The auxiliary storage device 13 stores data such as programs for executing various processes. Some of the programs stored in the auxiliary storage device 13 are loaded to the main storage device 12 and are executed by the CPU 11 to realize various processes. A storage unit 130 is equivalent to the main storage device 12 and the auxiliary storage device 13.

The sound sensor 14 is a sensor that detects a surrounding sound. The user I/F 15 displays various kinds of indispensable information under the control of the CPU 11 and is a touch panel enabling a user to perform manipulation input. The speaker 16 outputs unlabeled data under the control of the CPU 11. The sound sensor 14 and the speaker 16 may be externally attached.

The communication I/F 17 performs communication via a wired or wireless network. The communication of the communication I/F 17 is not limited to wireless or wired communication.

A program that realizes a process performed by the sensor data learning device 90 is provided to the sensor data learning device 90 by, for example, a storage medium 19 such as a compact disc read-only memory (CD-ROM).

The drive device 18 performs interface between the storage medium 19 (for example, a CD-ROM) set in the drive device 18 and the sensor data learning device 90.

A program that realizes various processes according to the embodiment to be described below is stored in the storage medium 19. The program stored in the storage medium 19 is installed to the sensor data learning device 90 via the drive device 18. The installed program can be executed by the sensor data learning device 90.

The storage medium 19 storing the program is not limited to a CD-ROM, but may be one or more non-transitory tangible media that have a structure in which a program can be read by a computer. A computer-readable storage medium includes not only a CD-ROM but also a portable recording medium such as a DVD disc or a USB and a semiconductor memory such as a flash memory.

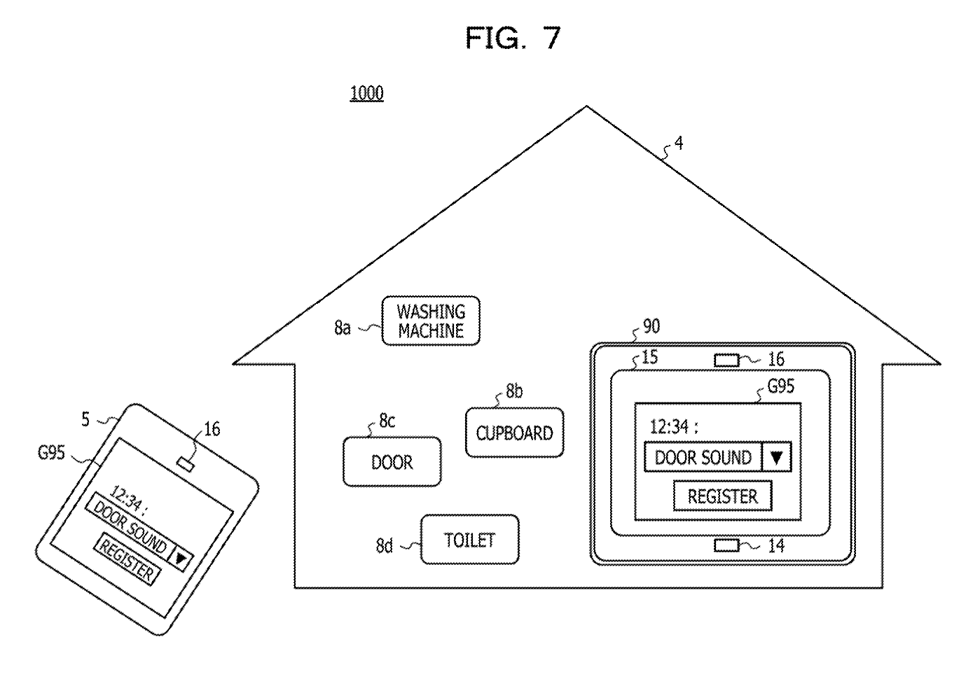

FIG. 7 is a diagram illustrating an application example of a watching system. In a watching system 1000 illustrated in FIG. 7, the sensor data learning device 90 is installed in a house 4. The sound sensor 14 of the sensor data learning device 90 detects living sounds of a washing machine 8a, a cupboard 8b, a door 8c, a toilet 8d, and the like in the house 4.

The sensor data learning device 90 displays a labeling confirmation screen G95 on the user I/F 15 to urge a user to label data in which no label is set.

When data which is a representative point among sound data detected by the sound sensor 14 is output from the speaker 15, the user 3 manipulates the labeling confirmation screen G95 to set a label of an output sound. The sensor data learning device 90 is accumulated by associating the representative point with the label set by the user 3 in the storage unit 130.

In a first example, living sounds of the washing machine 8a, the cupboard 8b, the door 8c, the toilet 8d, and the like are detected by the sound sensor 14 of the sensor data learning device 90 and labeling is performed with the user I/F 15 of the sensor data learning device 90. Therefore, only the sensor data learning device 90 may be installed in the house 4. The labeling may be performed with a terminal 5 of the user 3.

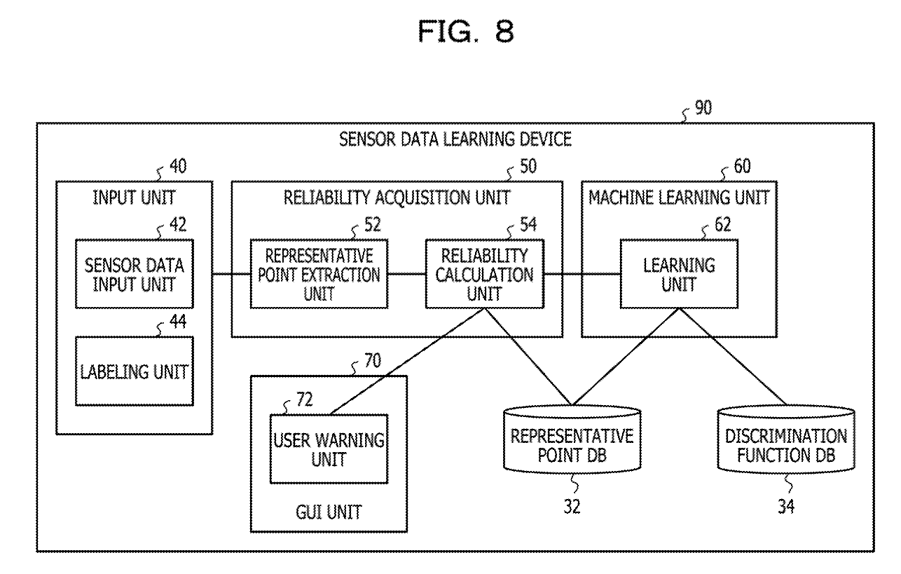

FIG. 8 is a diagram illustrating a functional configuration example of the sensor data learning device according to the first example. In FIG. 8, the sensor data learning device 90 mainly includes an input unit 40, a reliability acquisition unit 50, a machine learning unit 60, and a graphical user interface (GUI) unit 70. The input unit 40, the reliability acquisition unit 50, the machine learning unit 60, and the GUI unit 70 are realized through processes which a program installed in the sensor data learning device 90 causes the CPU 11 of the sensor data learning device 90 to execute. The storage unit 130 stores a representative point DB 32 and a discrimination function DB 34.

In FIG. 8, the processing units according to the first example are illustrated and others are not illustrated. In the first example, data initially detected by the sound sensor 14 and accumulated for a predetermined period may be clustered and representative points may be registered in the representative point DB 32 or a clustering process may be omitted.

Further, the input unit 40 includes a sensor data input unit 42 and a labeling unit 44. The sensor data input unit 42 inputs sound data detected by the sound sensor 14. The data is primarily stored in a predetermined storage region (a buffer or the like) in the storage unit 130.

The labeling unit 44 displays the labeling confirmation screen G95 on the user I/F 15 or the terminal 5 of the user 3, urges the user 3 to perform labeling, and acquires a label corresponding to reproduced data from the user 3. The label is associated with the data and is retained in the predetermined storage region. When a request for registering the label by the user 3 is received, the labeling unit 44 notifies the reliability acquisition unit 50 of the request.

The reliability acquisition unit 50 reads the data and the label accumulated in the predetermined storage region of the storage unit 130 in response to the registration request from the labeling unit 44 of the input unit 40 and calculates reliability representing likelihood of the labeling of the user 3.

Data newly detected by the sound sensor 14 is accumulated in the predetermined storage region by the sensor data input unit 42 and the user 3 is urged to perform the labeling at a predetermined interval or in sequence by the labeling unit 44. The label given by the user 3 is primarily retained in the predetermined storage region in association with the data.

A method of allowing the user 3 to perform the labeling may be any one of a first method of allowing the user 3 to label data accumulated during a fixed period and a second method of allowing the user 3 to label data in sequence whenever the data is detected by the sound sensor 14. By displaying the labeling confirmation screen G95 on the user I/F 15 or the user terminal 5, it is possible to perform the labeling in or outside of the house 4.

The reliability acquisition unit 50 calculates reliability of the labeling by the user 3 with reference to the representative point DB 32 in regard to the data and the label accumulated in the predetermined storage region. Further, the reliability acquisition unit 50 includes a representative point extraction unit 52 and a reliability calculation unit 54.

The representative point extraction unit 52 extracts a representative point similar to data detected by the sound sensor 14 from the representative point DB 32 and stores the representative point as a labeling history of the representative points from which the labels given by the user 3 are extracted in the representative point DB 32. The data and the label retained in the predetermined storage region of the storage unit 130 may be erased from the predetermined storage region whenever the data and the label are recorded in the labeling history of the representative point DB 32.

In a case in which data detected by the sound sensor 14 is not similar to any representative point stored in the representative point DB 32, the representative point extraction unit 52 stores the data as a new representative point along with a label given by the user 3 in the representative point DB 32.

According to the first example, in a case in which a plurality of representative points are obtained in advance by clustering, sound data detected by the sound sensor 14 is accumulated in the predetermined storage region for a predetermined period from the time of initial instruction to the house 4 of the user 3 of the sensor data learning device 90. Thereafter, clustering is performed by the reliability acquisition unit 50 and a representative point is extracted for each cluster and is registered in the representative point DB 32. After the representative point is registered in the representative point DB 32, the predetermined storage region may be initialized.

When the representative point is calculated by the clustering, a variance (for example, dispersion) calculated from sensor data input to the representative point may be retained and the statistical amount of the variance may be reflected in calculation of the reliability or a threshold (a distance or the like) of a collection range of the representative point. An amount (for example, a distance from the center of the cluster) calculated from the sensor data may be simultaneously retained as a history at the time of calculating the representative point and the value of the amount may be reflected in the calculation of the reliability or the threshold of a collection range of the representative point. Further, at the time of extracting the representative point, only one representative point may not be retained within a fixed range, but a plurality of representative points may be retained.

As the range of the representative point, not only points from a fixed distance or less may be collected, but previous representative points collected using a function (for example, a function of e^{-distance} or the like) in which a probability included in the representative point varies in accordance with the value of the distance may also be selected stochastically. When the representative points are collected, the representative point may not be collected at one nearest point, but allocation may be performed by weighting a plurality of near points. Also, the representative points may be selected by causing the number of previous representative points collected using a scheme such as sparse coding to be variable.

Distance between the pieces of data may not be calculated isotropically in each feature amount dimension, but any one distance function may be used among a distance function that has anisotropy such as a Mahalanobis distance, a distance function projected to a partial space, a distance function on a kernel function such as a radial basis function (RBF) kernel or a Bhattacharyya kernel, a distance function on a manifold obtained by manifold learning, an expansion distance function on a non-Euclidean space such as Bregman divergence, a distance function of performing nonlinear conversion such as an Lp norm, and a distance function learned by distance measurement learning.

At the time of calculating a distance, for example, data may be read from the sound sensor 14 and a distance space may dynamically be normalized using a normalized online learning method. Further, at the time of calculating a distance, temporally close data may be adjusted so that a distance is near or distant using a function of varying a value in accordance with a time at which data is input from the sound sensor 14.

In the first example, at the time of instruction to the house 4, the representative point DB 32 indicating a representative point of data detected by the sound sensor 14 and a distance at which the representative point is collected may be decided in advance based on empirical values. In this case, the above-described clustering process may be omitted. The representative point extraction unit 52 may merely select a representative point closest to data detected by the sound sensor 14 from the representative point DB 32.

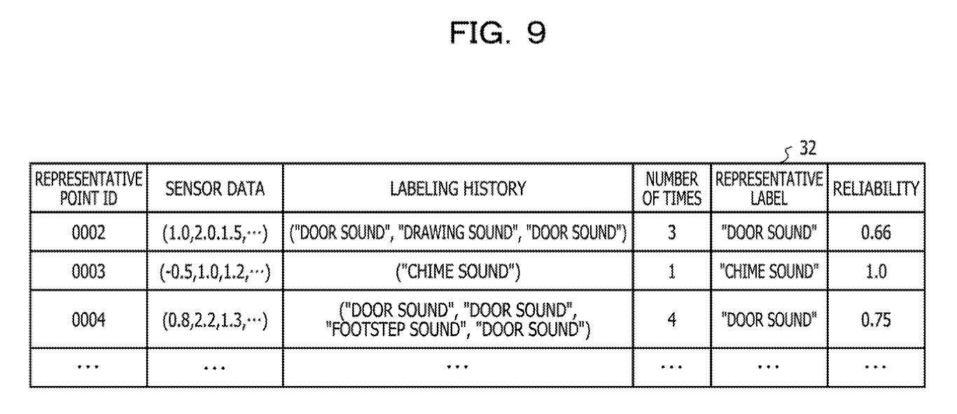

The reliability calculation unit 54 obtains reliability for each representative point using the representative point DB 32. The reliability is calculated for a representative point for which a label is high consistent and is calculated to be also lowered for a representative point for which a label is not consistent. In FIG. 9, the reliability will be described in detail along with description of a data configuration example of the representative point DB 32.

When the value of reliability becomes equal to or less than a threshold through the labeling of the user 3, the reliability calculation unit 54, the reliability calculation unit 54 may notify the GUI unit 70 of a warning in which data of the labeling is designated so that the user 3 can perform the labeling again.

The machine learning unit 60 mainly includes a learning unit 62 that performs the learning process 6p. The learning unit 62 decides a weight of a discrimination function using the reliability for each label. The weight of the discrimination function for each label is stored in the discrimination function DB 34.

The GUI unit 70 includes a user warning unit 72. When the reliability calculation unit 54 notifies the user warning unit 72 of a warning, the user warning unit 72 displays a message for urging the user 3 to reset the label on the user I/F 15 or the terminal 5 of the user 3 displayed on the labeling confirmation screen G95 and requests the user 3 to reset the immediately previously set label. The label set again by the user 3 is acquired by the labeling unit 44 of the input unit 40.

Next, the representative point DB 32 and the discrimination function DB 34 will be described. FIG. 9 is a diagram illustrating a first data configuration example of the representative point DB. In FIG. 9, the representative point DB 32 is a database that manages information regarding the representative points and has items such as a representative point ID, sensor data, a labeling history, the number of times, a representative label, and reliability.

The representative point ID is an identifier of each representative point. In the representative point DB 32, data initially accumulated for a predetermined period may be clustered and initial representative points may be registered. In the clustering for obtaining the representative points, the above-described scheme may be used.

The sensor data is data in which a feature amount of each audio feature serving as a representative point and detected by the sound sensor 14 is expressed with a multi-dimensional vector.

The labeling history indicates a label given to a representative point. The given label is referred to as an “input label” in some cases. A given date may be recorded for each label. The labels given by the user 3 may be recorded by a variable length array. The date may be a date on which a sound is detected by the sound sensor 14 or a date on which the user 3 gives a label. The label recorded in the labeling history is a recognition target name recorded in the discrimination function DB 34.

The number of times indicates the number of times the labeling is performed and is equivalent to the number of input labels recorded in the labeling history. The representative label indicates a label that is given to data of a representative point the largest number of times. The reliability is obtained with reference to the labeling history, the number of times, and the representative label and indicates the degree of confidence of the user 3 for the representative label.

The reliability is expressed by a ratio of the number of input labels identical to the representative label acquired from the labeling history to the number of times the labeling is performed.

$$Reliability = \frac{\begin{matrix}number of representative labels in \\ representative point labeling history\end{matrix}}{\begin{matrix}number of labels in representative point \\ labeling history\end{matrix}} \qquad [ Math . 1 ]$$

In this example, for sensor data (1.0, 2.0, 1.5, . . . ) with representative point ID “0002”, the labeling is performed three times. From the labeling history, it is indicated that the input labels are “door sound”, “drawing sound”, and “door sound”. The input label “door sound” which is the most in the labeling history is set as a representative label. The reliability of representative point ID “0002” is:

Reliability=2/3=0.66.

For sensor data (−0.5, 1.0, 1.2, . . . ) with representative point ID “0003”, the labeling is performed once. From the labeling history, it is indicated that the label “chime sound” is given. Since the sound recorded in the labeling history is only “chime sound”, “chime sound” is set as the representative label. The reliability of representative point ID “0003” is:

Reliability=1/1=1.0.

For sensor data (0.8, 2.2, 1.3, . . . ) with representative point ID “0004”, the labeling is performed four times. From the labeling history, it is indicated that the input labels are “door sound”, “door sound”, “footstep sound” and “door sound”. Since a sound which is the most in the labeling history recorded is “door sound”, “door sound” is set as a representative label. The reliability of representative point ID “0004” is:

Reliability=3/4=0.75.

Various methods of calculating the reliability are considered, as will be described above, and any calculation method may be applied. As a calculation method other than Math. 1, a constant a may be added to the denominator and the numerator of Math. 1, as indicated in Math. 2.

$$\begin{matrix}Reliability = \frac{\begin{matrix}number of representative labels in \\ representative point labeling history + α\end{matrix}}{\begin{matrix}number of labels in representative point \\ labeling history + α\end{matrix}} & [ Math . 2 ] \\ ( α \text{:} constant ) & \end{matrix}$$

In Math. 2, in a case in which the number of representative labels included in the labeling history, that is, the number of pieces of data collected at the representative points is small, degradation of the value of the reliability is difficult. In Math. 2, when the number of pieces of data allocated to the representative points is small, slight variation in selection of the representative labels is suppressed.

The numerator and the denominator of Math. 1 may be raised to the power of a constant β.

$$\begin{matrix}Reliability = {( \frac{\begin{matrix}number of representative labels in \\ representative point labeling history\end{matrix}}{\begin{matrix}number of labels in representative point \\ labeling history\end{matrix}} )}^{β} & [ Math . 3 ] \\ ( β \text{:} constant ) & \end{matrix}$$

In Math. 3, in a case in which a value greater than 1 is given as β, the reliability is considerably lowered when the number of nonidentical labels is large. According to this effect, it is possible to impose a considerable penalty in a case in which the nonidentity of the labels increases.

When the degree of nonidentity of labels is equal to or less than a fixed value as in Math. 4, a process of lowering the reliability may be performed.

$$\begin{matrix}Reliability = \{ \begin{matrix}{γ}_{1} & ( \frac{\begin{matrix}case in which value of number of representative \\ labels in representative point labeling history\end{matrix}}{\begin{matrix}number of labels in representative point \\ labeling history\end{matrix}} \begin{matrix}is greater than \\ threshold\end{matrix} ) \begin{matrix}( {γ}_{1} , {γ}_{2} \text{:} \\ constant )\end{matrix} \\ {γ}_{2} & ( Otherwise )\end{matrix} & [ Math . 4 ] \\ ( * {γ}_{2} is considerably low value such as 0 , for example ) & \end{matrix}$$

Two or more of the Math. 1 to Math. 4 described above may be combined. Math. 1 to Math. 4 are calculation examples in which a penalty is imposed when the consistency of the labeling decreases, that is, the reliability is lowered.

Alternatively, in a case in which the same label is given continuously a fixed number of times or more, a process of raising the reliability may be performed using one of a case in which the same label is given for a fixed period (1 week or the like) and a case in which the labels are given by a fixed number of times or at a fixed ratio or more within a fixed period.

At the time of determining the reliability, the value of the reliability may be changed in accordance with distances from the previous collected representative points.

Since a temporal change of data is considered at the time of determining the reliability, a time at which the label is given may be reflected at the previous collected representative points. In a nighttime zone, the reliability may be lower than in an activity daytime zone. This is because it is considered that the nighttime in a daily life of the user 3 is a time zone in which the user 3 is tired, and thus a determination ability of the user 3 is duller than in the daytime zone and precision of the labeling degrades.

At the time of determining the reliability, the user 3 may adjust the reliability according to a situation of the time of the labeling of the user 3 using information regarding a time indispensable for the labeling or a time taken for the user 3 to perform the labeling. Information obtained from an external sensor such as a pyroelectric sensor may be used. An amount of motion in that time zone can be known from a time-series output of the pyroelectric sensor. Therefore, whether the labeling is performed in a busy time of the user 3 or performed in a calm situation of the user 3 may be determined and the reliability may be adjusted based on a determination result.

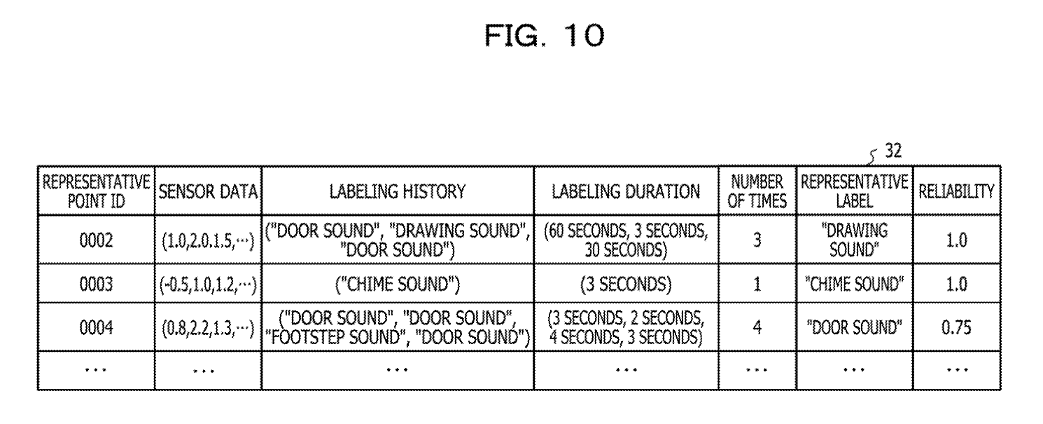

FIG. 10 is a diagram illustrating a second data configuration example of the representative point DB. In FIG. 10, a representative point DB 32-2 is a database that manages information regarding representative points and has an item of a labeling duration in addition of the first data configuration example.

The labeling duration indicates a time indispensable in the labeling of the user 3. In the labeling duration, durations are recorded in order of the labels recorded in the labeling history.

In a case in which a duration taken to set a label of the labeling history is equal to or greater than a threshold time, the label is not adopted. In this example, in a case in which 10 seconds are set as the threshold time, first and third labels “door sound” of the labeling history of the representative point ID “0002” are neglected.

The weighting may be performed on each of the labels of the labeling history using a function (for example, a function such as e^{-t}) of attenuating a weight by the time taken to perform the labeling using the representative point DB 32-2.

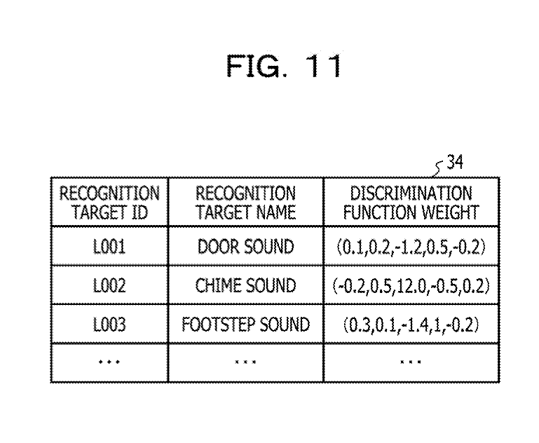

FIG. 11 is a diagram illustrating a data configuration example of the discrimination function DB. In FIG. 11, the discrimination function DB 34 has items such as a recognition target ID, a recognition target name, and a discrimination function weight. The recognition target ID indicates an identifier of the kind of sound (that is, a label). The recognition target name indicates a kind of sound (that is, a label). The discrimination function weight is equivalent to a coefficient of the discrimination function f.

In this example, an identifier of a label “door sound” is the recognition target ID “L001” and a weight of the discrimination function for “door sound” indicates (0.1, 0.2, −1.2, 0.5, −0.2). An identifier of the label “chime sound” is recognition target ID “L002” and a weight of the discrimination function for “chime sound” indicates (−0.2, 0.5, 12.0, −0.5, 0.2). An identifier of the label “footstep sound” is recognition target ID “L003” and a weight of the discrimination function for “footstep sound” indicates (0.3, 0.1, −1.4, 1, −0.2).

In this way, the discrimination function f with high precision can be obtained by calculating a weight in regard to the representative point using the reliability of the labeling by the user 3 and the number of times the labeling is performed for each representative point.

Weight=number of pieces of data×reliability [Math. 5]

The weight is obtained by Math. 5.

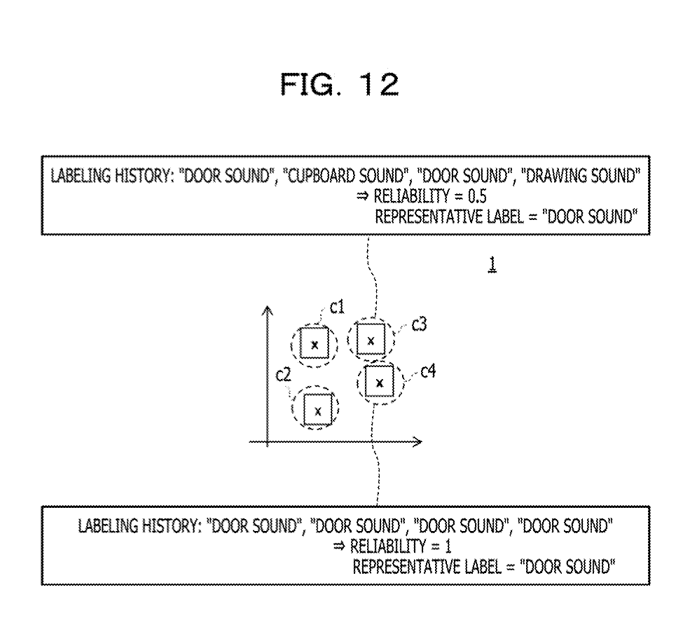

FIG. 12 is a diagram illustrating a calculation example of reliability according to the first example. In FIG. 12, an example in which the pieces of data are classified into four clusters c1, c2, c3, and c4 in a feature amount space 1 will be described. The reliability is assumed to be calculated by Math. 1.

In a case in which the labeling history of the cluster c3 indicates “door sound”, “cupboard sound”, “door sound”, and “drawing sound”, a representative label is “door sound” which occurs most frequently in the labeling history. Since “door sound” occurs twice among four times of the labeling, reliability of 0.5 (=2/4) is obtained.

A labeling history of the cluster c4 indicates “door sound”, “door sound”, “door sound”, and “door sound” and the user 3 gives the same label consistently. The representative label is “door sound”. Reliability of 1.0 (=4/4) is obtained.

In this way, even in a case in which the labeling is performed the same number of times, that is, the number of pieces of data is the same, the reliability differs. By deciding the weight of the discrimination function based on the reliability, it is possible to reliably discriminate the data in which the degree of confidence of the user 3 is high.

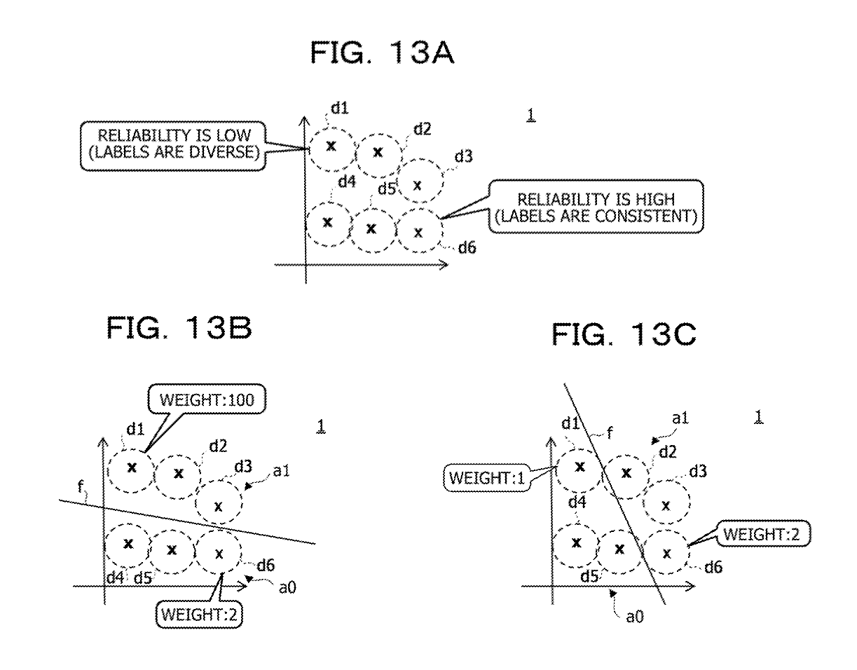

A difference in the discrimination function f of “door sound” between the first example and a related technology in which the reliability in the first example is not used is illustrated in FIGS. 13A to 13C. FIGS. 13A to 13C are diagrams illustrating the difference in the discrimination function according to the related technology and the first example.

In FIG. 13A, it is indicated that the pieces of data are grouped into clusters d1, d2, d3, d4, d5, and d6. Of the six clusters, the cluster d1 is a cluster in which the degree of confidence of the user 3 is low since the number of pieces of data is large, but is diverse without consistency in the labeling. The cluster d6 is a cluster in which the degree of confidence of the user 3 is high since the number of pieces of data is small, but is consistent in the labeling.

FIG. 13B illustrates an example of the discrimination function f according to the related technology. By the weighting of the number of pieces of data, a weight of “100” is set in the cluster d1 and a weight of “2” is set in the cluster d6. Then, the discrimination function f is set so that the data of the clusters d1, d2, and d3 is determined to belong to the door sound region a1 and the data of the clusters d4, d5, and d6 is determined to belong to the non-door sound region a0.

FIG. 13C illustrates an example of the discrimination function f according to the first example. By the reliability of the labeling by the user 3, a weight of “1” is set in the cluster d1 and a weight of “2” is set in the cluster d6. Then, the discrimination function f is set so that the data of the clusters d2, d3, and d6 is determined to belong to the door sound region a1 and the data of the clusters d1, d4, and d5 is determined to belong to the non-door sound region a0.

In the related technology, in a case in which the cluster d1 determined to belong to the door sound region a1 uses the discrimination function f according to the first example, the data is determined to belong to the non-door sound region a0. In the related technology, in a case in which the cluster d6 determined to belong to the non-door sound region a0 uses the discrimination function f according to the first example, the data is determined to belong to the door sound region a1.

The cluster d6 in which the user 3 consistently labels “door sound” is recognized as a door sound even when the number of pieces of data is small.

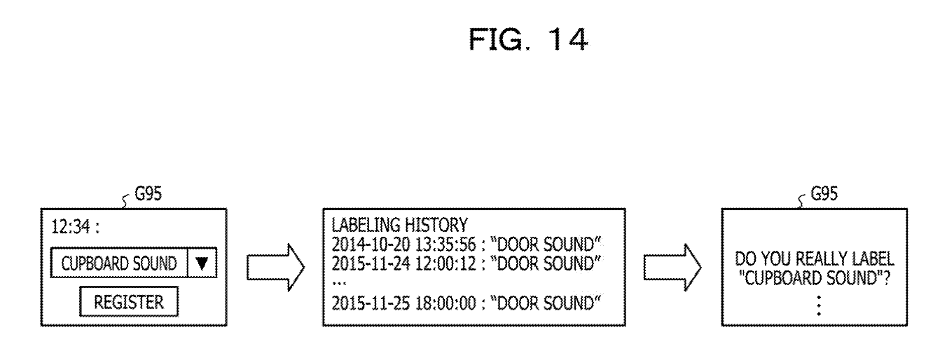

In the first example, in a case in which different labels are given in a state in which the same label is consistently given previously, a warning urging the user 3 to perform the labeling again may be performed. FIG. 14 is a diagram illustrating an example of a case in which the user is warned according to the first example. In FIG. 14, the user 3 labels “cupboard sound” in regard to a sound arriving from the speaker 16 on the labeling confirmation screen G95.

The reliability calculation unit 44 of the sensor data learning device 90 refers to the labeling history of the representative point closest to the data labeled by the user 3 in the representative point DB 32. In this example, it is indicated that “door sound” is all labeled.

The reliability calculation unit 44 determines that different labeling is performed at this time on the data labeled consistently with “door sound” and notifies the user warning unit 72 of a warning. The user warning unit 72 notified of the warning displays “Do you really label “cupboard sound”?” or the like on the labeling confirmation screen G95 displayed on the user I/F 15 and urges the user 3 to confirm the labeling.

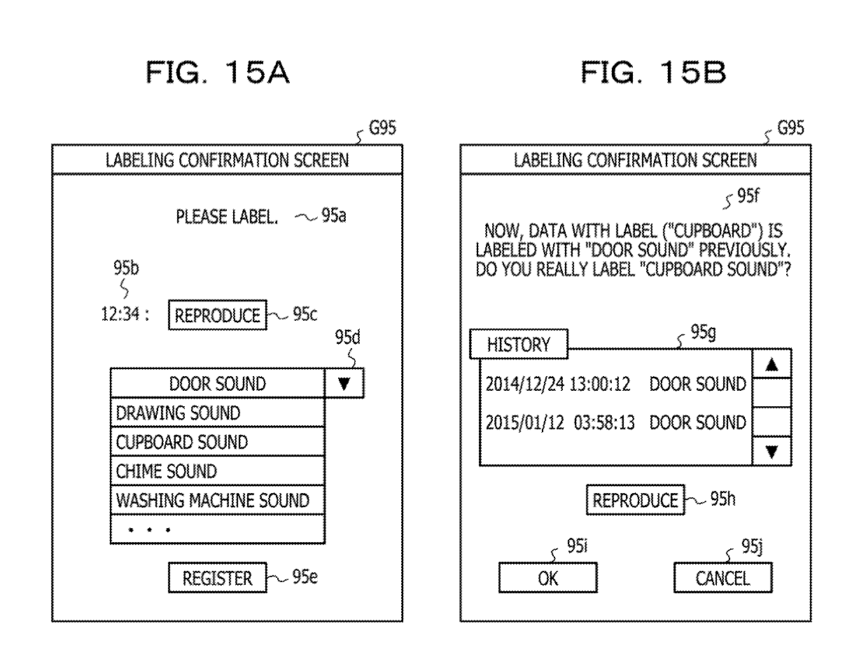

FIGS. 15A and 15B are diagrams illustrating an example of a labeling confirmation screen according to the first example. Content displayed at the time of labeling unlabeled data is displayed on the labeling confirmation screen G95 illustrated in FIG. 15A. A message 95a, a time 95b, a reproduction button 95c, a label setting region 95d, a registration button 95e, and the like are displayed on the labeling confirmation screen G95.

The message 95a indicates a message for urging the user 3 to perform labeling, such as “Please label”. The time 95b indicates a time at which a sound is detected. In this example, “12:34” is indicated. The reproduction button 95c is a button for reproducing the sound detected at the time 95b.

The label setting region 95d is a region in which the user 3 sets the label. In this example, it is indicated that a label list is displayed in a pull-down manner and the user 3 selects “door sound” from the label list. The setting method is not limited to this example.

The registration button 95e is a button for registering the label set in the label setting region 95d. In this example, when the user 3 sets the registration button 95e, a distance from the sound data of “12:34” in the representative point DB 32 is within a threshold equivalent to the size of the cluster and the representative point closest to the sound data of “12:34” is specified. The label set in the label setting region 95d by the user 3 is added and recorded in the labeling history of the specified representative point.

On the labeling confirmation screen G95 illustrated in FIG. 15B, content displayed by the user warning unit 72 notified of a warning by the reliability calculation unit 54 is displayed when the data is labeled. A message 95f, a history 95g, a reproduction button 95h, an OK button 95i, a cancelation 95j, and the like are displayed on the labeling confirmation screen G95.

The message 95f indicates a message for urging the user 3 to confirm the labeling. The message 95f indicates, for example, a message “Now, data with label (“cupboard sound”) is labeled with “door sound” previously. Do you really label “cupboard sound”?”.

The history 95g indicates history information of previous labeling. The history 95g indicates history information such as:

“2014/12/24 13:00:12 door sound

2015/01/12 03:58:13 door sound”.

The reproduction button 95h is a button for reproducing a confirmation target sound. In response to selection the reproduction button 95h, the content illustrated in FIG. 15A may be displayed. The user 3 sets a label again in the label setting region 95d.

The OK button 95i is a button for registering the set label. In this example, when the OK button 95i is selected, setting of “cupboard sound” is registered for the sound previously labeled with “door sound”. The cancellation 95j is a button for cancelling the registration. In this example, when the cancellation 95j is selected, the history information in regard to a representative point related to a sound for which “cupboard sound” is set is not added at this time.

A method of allowing the user 3 to perform the labeling may be any one of the first method of allowing the user 3 to label data accumulated during a fixed period and the second method of allowing the user 3 to label data in sequence whenever the data is detected by the sound sensor 14.

The first method of allowing the user 3 to label data accumulated during a fixed period and the second method of allowing the user 3 to label data in sequence whenever the data is detected, the first and second methods being performed by the labeling unit 44, will be described.

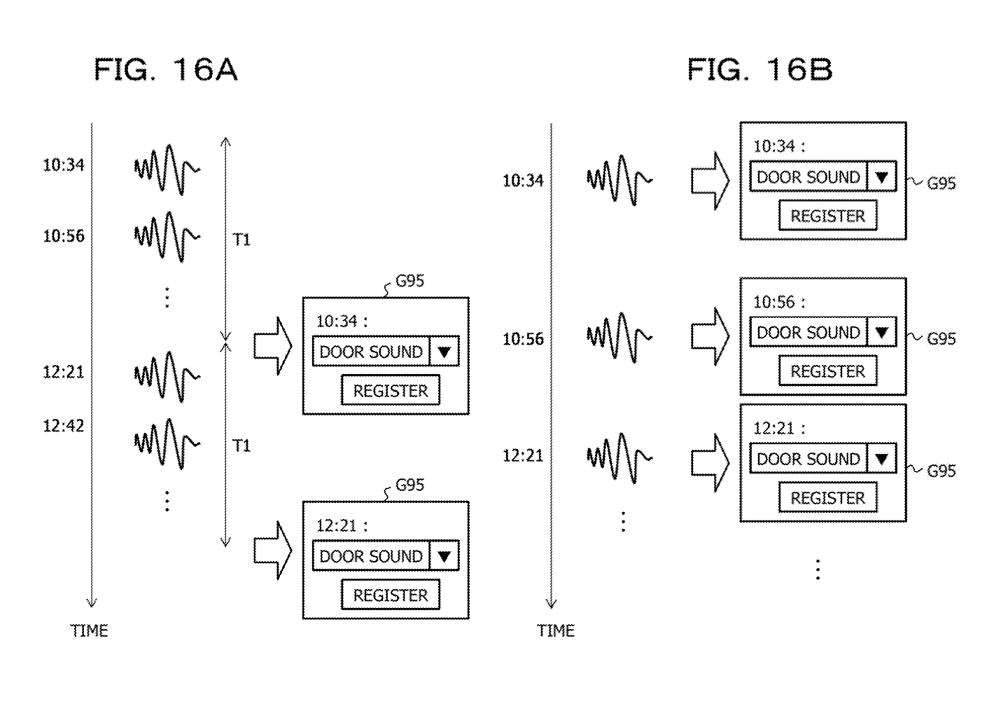

FIGS. 16A and 16B are diagrams illustrating timing examples of the labeling. FIG. 16A illustrates an example in which the labeling is performed in accordance with the first method. The labeling confirmation screen G95 is displayed on the user I/F 15 or the terminal 5 to urge the user 3 to label a plurality of pieces of data detected at a predetermined interval T1 by the sound sensor 14 and accumulated in the sensor data input unit 42. The user 3 labels the plurality of pieces of data accumulated at the predetermined interval T1.

FIG. 16B illustrates an example in which the labeling is performed in accordance with the second method. Whenever the sound sensor 14 detects a sound, the sensor data input unit 42 notifies the labeling unit 44 of the sound. Then, the labeling unit 44 displays the labeling confirmation screen G95 on the user I/F 15 or the terminal 5 to urge the user 3 to perform the labeling. The user 3 labels one piece of data.

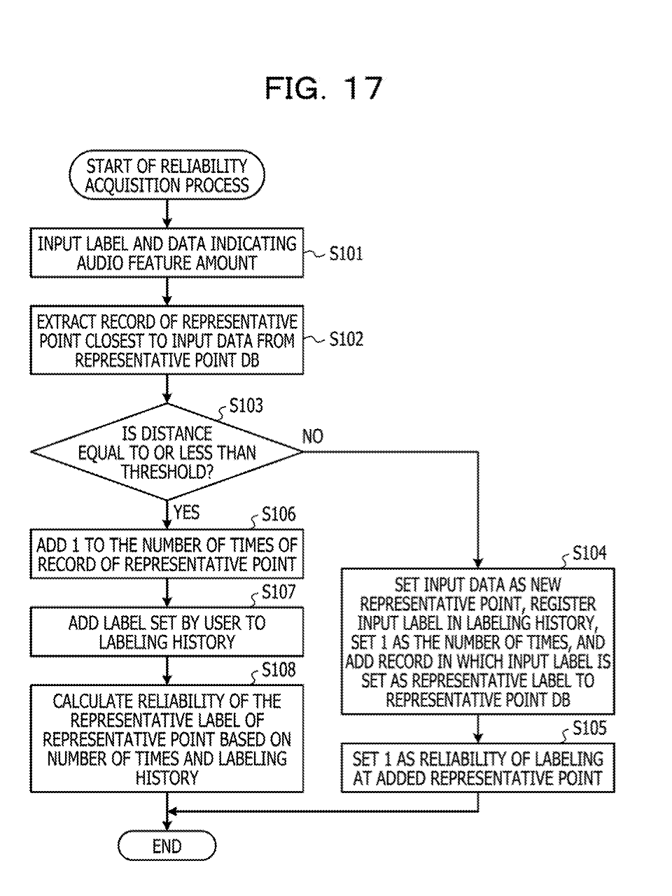

Next, a reliability acquisition process by the reliability acquisition unit 50 will be described. FIG. 17 is a flowchart illustrating the reliability acquisition process according to the first example. The reliability acquisition unit 50 starts the reliability acquisition process in response to reception of a label registration request from the input unit 40.

In FIG. 17, the representative point extraction unit 52 of the reliability acquisition unit 50 inputs a label and data indicating an audio feature amount from a predetermined storage region of the storage unit 130 (step S101) and extracts a record of the representative point closest to the input data from the representative point DB 32 (step S102). Of the sensor data (representative points) stored in the representative point DB 32, the record of the sensor data closest to the input data is extracted.

The representative point extraction unit 52 determines whether the distance between the extracted representative point and the input data is equal to or less than a threshold (step S103). In a case in which the distance between the extracted representative point and the input data exceeds the threshold (No in step S103), the representative point extraction unit 52 set the input data as a new representative point, sets a representative point ID, records the input label in the labeling history, sets 1 as the number of times, and adds a record in which an input label is set as a representative label to the representative point DB (step S104). The representative point extraction unit 52 notifies the reliability calculation unit 54 of the representative point ID.

The reliability calculation unit 54 specifies the record of the representative point ID notified by the representative point extraction unit 52 and sets 1 as the reliability of the labeling in the added representative point (step S105). The reliability calculation unit 54 can determine the representative point is new since the number of times is 1. In this case, the reliability is set to 1. Thereafter, the reliability acquisition unit 50 ends the reliability acquisition process. After the reliability acquisition process ends, a learning process by the machine learning unit 60 starts.

Conversely, in a case in which the distance between the extracted representative point and the input data is equal to or less than the threshold (Yes in step S103), the representative point extraction unit 52 adds 1 to the number of times of the record of the representative point (step S106) and adds a label set by the user 3 to the labeling history of the record (step S107). A date may be added along with the label. The representative point extraction unit 52 notifies the reliability calculation unit 54 of the representative point ID.

The reliability calculation unit 54 specifies the record of the representative point ID notified by the representative point extraction unit 52 and calculates reliability of the representative label of the representative point based on the number of times and the labeling history of the specified record (step S108). The calculated reliability is set in the record. Thereafter, the reliability acquisition unit 50 ends the reliability acquisition process. After the reliability acquisition process ends, the learning process by the machine learning unit 60 starts.

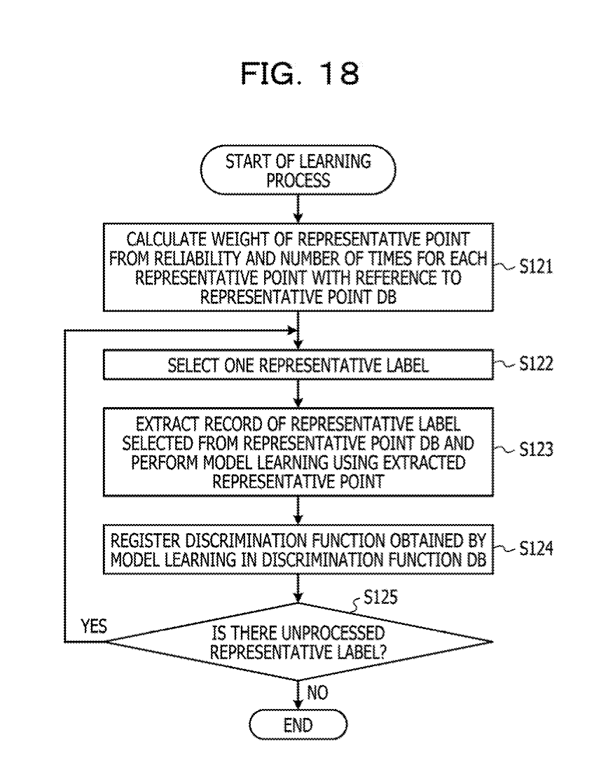

Next, the learning process by the machine learning unit 60 will be described. FIG. 18 is a flowchart illustrating the learning process according to the first example. When the representative point DB 32 is updated to some extent at a predetermined interval (for example, an interval of several hours), a machine learning process by the machine learning unit 60 is preferably performed.

In FIG. 18, the machine learning unit 60 calculates a weight of the representative point from the reliability and the number of times for each representative point with reference to the representative point DB 32 (step S121).

The machine learning unit 60 selects one representative label (step S122), extracts a record of the representative label selected from the representative point DB 32, and performs model learning using the extracted representative point (step S123).

The machine learning unit 60 registers a discrimination function obtained by the model learning in the discrimination function DB 34 (step S124). That is, the coefficient of the discrimination function is set in a discrimination function weight of the discrimination function DB 34.

Then, the machine learning unit 60 determines whether there is an unprocessed representative label (step S125). When there is the unprocessed representative label (Yes in step S125), the machine learning unit 60 returns the process to step S122 and repeats the above-described processes. Conversely, when all the representative labels are processed (No in step S125), the machine learning unit 60 ends the learning process.

Next, a second example in which the discrimination function DB 34 obtained in the first example is used will be described. Since the hardware configuration or the like of the sensor data learning device 90 is the same as that of the first example, the description thereof will be omitted.

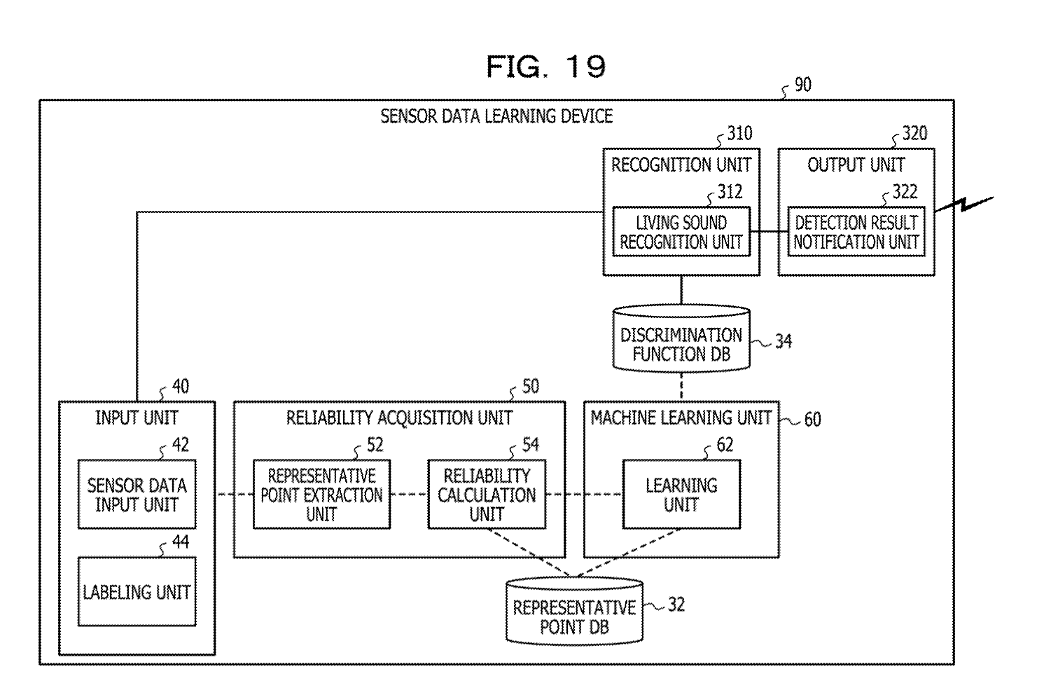

FIG. 19 is a diagram illustrating a functional configuration example of a sensor data learning device according to the second example. In FIG. 19, the sensor data learning device 90 further includes a recognition unit 310 and an output unit 320 in addition to the functional configuration of the first example. The recognition unit 310 and the output unit 320 are realized through a process which a program installed in the sensor data learning device 90 causes the CPU 11 of the sensor data learning device 90 to perform. The same reference numerals are given to the same portions of those of the first example and the description thereof will be omitted. Portions according to the first example are indicated by dotted lines and portions according to the second example are indicated by sold lines.

The recognition unit 310 determines whether data detected by the sound sensor 14 is a living sound. The recognition unit 310 mainly includes a living sound recognition unit 312. When data detected by the sound sensor 14 is received from the sensor data input unit 42 of the input unit 40, the living sound recognition unit 312 determines whether the data is one living sound using the discrimination function DB 34. In a case in which the living sound is detected, the recognition unit 310 notifies the output unit 320 of a detection result in which a label for specifying the living sound is designated.

The output unit 320 notifies a server providing a service of a detection result. The output unit 320 mainly includes a detection result notification unit 322. The detection result notification unit 322 transmits the detection result received from the living sound recognition unit 312 to a server performing a watching service or the like via the communication I/F 17.

The detection result includes a recognition target (that is, a label indicating a kind of sound) and information regarding a time at which data is detected by the sound sensor 14. The server accumulates the detection result and provides, for example, a service for notifying a security company or the like of abnormality in a case in which a toilet sound is not detected or a service for notifying family members of people living in the house 4 of home returning or going-out in accordance with detection of a door sound.

After the processes in the first example may be performed for a fixed period from the time of introducing the sensor data learning device 90, processes in the second example may be performed. Alternatively, convergence determination of the learning process may be performed in the first example and the processes in the second example may start in accordance with the end of the processes in the first examples. Even after the processes in the second example start, the processes in the first example may be performed in parallel.

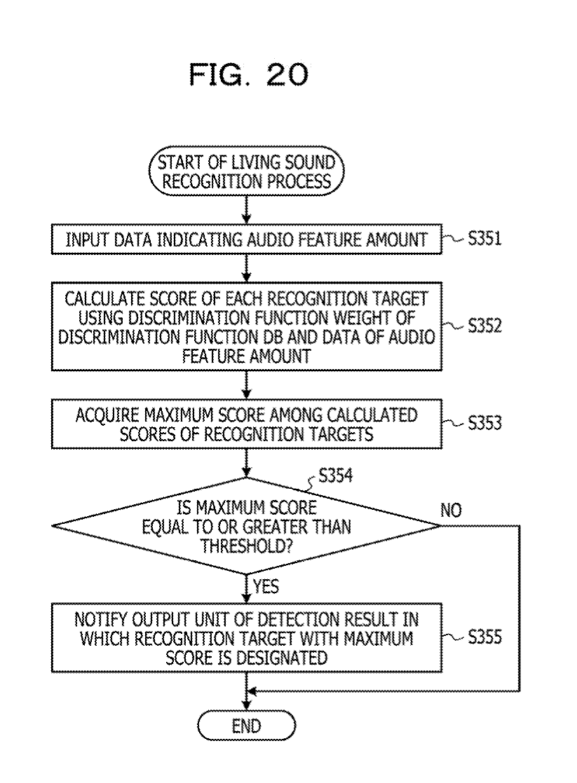

A living sound recognition process by the living sound recognition unit 312 will be described. FIG. 20 is a flowchart illustrating the living sound recognition process. In FIG. 20, the living sound recognition unit 312 inputs data indicating an audio feature amount (step S351).

The living sound recognition unit 312 calculates a score of each recognition target using data of the audio feature amount and the discrimination function weight of the discrimination function DB 34 (step S352) and acquires a maximum score among the calculated scores of the recognition targets (step S353).

Then, the living sound recognition unit 312 determines whether the acquired maximum score is equal to or greater than a threshold (step S354). In a case in which the maximum score is less than the threshold (No in step S354), the living sound recognition unit 312 ends the living sound recognition process.

Conversely, when the maximum score is equal to or greater than the threshold (Yes in step S354), the living sound recognition unit 312 notifies the output unit 320 of a detection result in which the recognition target with the maximum score is designated (step S355) and ends the living sound recognition process. When the detection result is received, the detection result notification unit 322 of the output unit 320 notifies a notification destination such as a pre-decided server of the detection result.

The living sound recognition process in a case in which the discrimination function DB 34 illustrated in FIG. 11 is used will be described. The data indicating the input audio feature amount is assumed to be (0.1, 0.1, 0.1, 0.1, 1.0) and a threshold Th is assumed to be 1.0.

When a discrimination function weight of the recognition target name “door sound” is applied, a score of “−0.24” is obtained. In addition, when a discrimination function weight of the recognition target name “chime sound” is applied, a score of “1.38” is obtained. Further, when a discrimination function weight of the recognition target name “footstep sound” is applied, a score of “−0.2” is obtained.

Since the score of the chime sound indicating the maximum score is greater than the threshold Th=1.0, an input sound can be determined to be the chime sound.

As described above, by reflecting the reliability of the labeling indicating the kind of sound given to the data collected by the user 3 in the weight of the data to perform learning, it is possible to improve recognition precision of the detected data without an influence on the number of collected data.

The present disclosure is not limited to the specifically disclosed examples, but can be modified or changed without departing from the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A sensor data learning method executed by a computer, comprising:
acquiring sensor data;
collecting the acquired sensor data at each representative point of a plurality of pieces of similar sensor data; and
calculating reliability of a data type associated with the representative point based on the data type granted to each of the plurality of pieces of sensor data.

2. The sensor data learning method of claim 1, further comprising:
accumulating the acquired sensor data for a predetermined period;
displaying a screen on which the data type is granted for each predetermined period on a display; and
acquiring the data type granted to each of the plurality of pieces of sensor data accumulated for the predetermined period.

3. The sensor data learning method of claim 1, further comprising:
display a screen in which the data type is granted whenever the sensor data is acquired on a display; and
acquiring the data type granted to the sensor data.

4. The sensor data learning method of claim 1, further comprising:
acquiring weight of a discrimination function of each data type based on the reliability and number of pieces of sensor data collected for each representative point; and
deciding the discrimination function of each data type based on a learning process.

5. The sensor data learning method of claim 1, wherein the reliability is calculated based on a ratio of the maximum number of data types to a total number of the plurality of pieces of sensor data based on the data type granted to each of the plurality of pieces of sensor data of each representative point.

6. The sensor data learning method of claim 1, further comprising:
adding the acquired sensor data as the representative point to a list in a case in which the acquired sensor data is not similar to the sensor data of a certain representative point of the list.

7. The sensor data learning method of claim 1, further comprising:
specifying a data type in which a highest score is obtained based on a discrimination function of each data type to which the weight is applied; and
outputting a detection result in which the data type is designated in a case in which a score of the specified data type is equal to or greater than a threshold.

8. A sensor data learning device comprising:
a memory; and
a processor coupled to the memory and configured to:
acquire sensor data;
collect the acquired sensor data at each representative point of a plurality of pieces of similar sensor data; and
calculate reliability of a data type associated with the representative point based on the data type granted to each of the plurality of pieces of sensor data.
